(19) United States
(12) Patent Application Publication
(10) Pub. No.: US 2026/0314735 A1
(43) Pub. Date: Oct. 15, 2026

(54) Safety Headwear Systems and Accessories

(71) Applicant: Milwaukee Electric Tool Corporation, Brookfield, WI (US)

(72) Inventors: Daniel R. Janosch, New Berlin, WI (US); Katherine Tran, Waukesha, WI (US); Luke D. Ramlow, Milwaukee, WI (US); Joshua A. Ebinger, Oconomowoc, WI (US)

(21) Appl. No.: 19/556,409

(22) Filed: Mar. 4, 2026

Related U.S. Application Data
(60) Provisional application No. 63/788,920, filed on Apr. 15, 2025.
(60) Provisional application No. 63/814,789, filed on May 30, 2025.

(51) Int. Cl. A42B 3/04; F21V 21/08; F21Y 115/10

(52) U.S. Cl. CPC A42B 3/0446; F21V 21/08; F21Y 2115/10

(57) ABSTRACT

A lighting assembly supported by safety headwear is provided. In various embodiments, the lighting assembly includes a headlamp, a bracket configured to couple to the safety headwear and support the headlamp at a front of the safety headwear, a battery pack, and mounting bracket configured to couple to the safety headwear and support the battery pack at a rear of the safety headwear. In specific embodiments, the headlamp includes a red light. In specific embodiments, the battery pack includes one or more red lights.

### CROSS-REFERENCE TO RELATED PATENT APPLICATIONS

The present application claims the benefit and priority to U.S. Provisional Application No. 63/814,789 filed on May 30, 2025, and to U.S. Provisional Application No. 63/788,920 filed on Apr. 15, 2025, which are incorporated herein by reference in their entireties.

### BACKGROUND OF THE INVENTION

The present disclosure is directed generally to the field of hard hats. The present disclosure relates specifically to a hard hat lighting system. Hard hats are often used in poorly illuminated areas. Hard hat use in high-risk environments may provide added protection for head injury. A lighting system may assist with vision in poorly lit or low visibility environments.

### SUMMARY OF THE INVENTION

One embodiment of the invention relates to a hard hat system including a hard hat and a lighting system. The hard hat includes a shell that includes an exterior surface and an interior surface that defines a cavity. The hard hat includes a front mounting ridge extending outward from a front of the exterior surface of the shell and a rear mounting ridge extending outward from a rear of the exterior surface of the shell. The lighting system includes a first bracket configured to removably engage the front mounting ridge and a headlamp supported by the first bracket. The headlamp includes a first lighting element configured to emit a red light forward, in a first direction. The lighting system further includes a second bracket configured to removably engage the rear mounting ridge and a power source supported by the second bracket. The power source includes a second lighting element configured to emit a red light rearward, in a second direction that is opposite the first direction.

Another embodiment of the invention relates to a hard hat system including a hard hat. The hard hat includes a shell that includes an exterior surface and an interior surface. The hard hat system includes a first mounting ridge extending outward from the exterior surface of the shell and a second mounting ridge positioned on an opposite portion of the shell from the first mounting ridge. The second mounting extending outward from the exterior surface of the shell. The hard hat system includes a headlamp supported relative to the first mounting ridge via a first mounting bracket and a battery pack supported relative to the second mounting ridge via a second mounting bracket. The headlamp includes a plurality of lighting elements. At least one of the plurality of lighting elements is configured to emit a red light in a first direction. The battery pack includes a battery lighting element configured to emit a red light in a second direction that is opposite the first direction.

Another embodiment of the invention relates to a hard hat system including a hard hat. The hard hat includes a shell that includes an exterior surface and an interior surface that defines a cavity. The hard hat includes a mounting ridge extending outward from the exterior surface of the shell. The mounting ridge includes opposing edges that protrude away from opposing sides of the mounting ridge. The hard hat system includes a mounting bracket coupled to the mounting ridge and a power source supported by the mounting bracket. The mounting bracket includes opposing arms that engage between the shell and the opposing edges of the mounting ridge. The power source is configured to supply electrical power to an accessory coupled to the hard hat. The power source includes a housing with a rear surface facing away from the hard hat and a pair of lighting elements positioned on the rear surface of the housing. Each of the pair of lighting elements are configured to emit red light.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a front perspective view of safety headwear, according to an exemplary embodiment.

FIG. 2 is a rear perspective view of the safety headwear of FIG. 1, according to an exemplary embodiment.

FIG. 3 is a front perspective view of a lighting assembly coupled to safety headwear, according to an exemplary embodiment.

FIG. 4 is a rear perspective view of the lighting assembly of FIG. 3 coupled to safety headwear, according to an exemplary embodiment.

FIG. 5 is a perspective view of the lighting assembly of FIG. 3 coupled to safety headwear, according to an exemplary embodiment.

FIG. 6 is a rear perspective view from below of the lighting assembly of FIG. 3 coupled to safety headwear, according to an exemplary embodiment.

FIG. 7 is a rear perspective view of the lighting assembly of FIG. 3 coupled to safety headwear, according to an exemplary embodiment.

FIG. 8 is a top plan view below of the lighting assembly of FIG. 3 coupled to safety headwear, according to an exemplary embodiment.

FIG. 9 is a bottom plan view below of the lighting assembly of FIG. 3 coupled to safety headwear, according to an exemplary embodiment.

FIG. 10 is a front view of the lighting assembly of FIG. 3 coupled to safety headwear, according to an exemplary embodiment.

FIG. 11 is a perspective view of a first portion of the lighting assembly coupled to safety headwear, according to an exemplary embodiment.

FIG. 12 is a detailed front view of the first portion of the lighting assembly of FIG. 11 coupled to safety headwear of FIG. 11, according to an exemplary embodiment.

FIG. 13 is a perspective view of the first portion of the lighting assembly of FIG. 11, according to an exemplary embodiment.

FIG. 14 is a perspective view of the first portion of the lighting assembly of FIG. 11, according to an exemplary embodiment.

FIG. 15 is an exploded view of the first portion of the lighting assembly of FIG. 11, according to an exemplary embodiment.

FIG. 16 is a perspective view of a second portion of the lighting assembly coupled to safety headwear, according to an exemplary embodiment.

FIG. 17 is a perspective view of the second portion of the lighting assembly, according to an exemplary embodiment.

FIG. 18 is an exploded view of the second portion of the lighting assembly, according to an exemplary embodiment.

FIG. 19 is a detailed view of the second portion of the lighting assembly of FIG. 16, according to an exemplary embodiment.

FIG. 20 is a left side view of the second portion of the lighting assembly coupled to the safety headwear, according to an exemplary embodiment.

FIG. 21 is a right side view of the second portion of the lighting assembly coupled to the safety headwear, according to an exemplary embodiment.

FIG. 22 is a detailed view of a connector of the lighting assembly in a first, closed position, according to an exemplary embodiment.

FIG. 23 is a detailed view of the connector of the lighting assembly in a second, open position, according to an exemplary embodiment.

FIG. 24 is a front perspective view of the lighting assembly, according to an exemplary embodiment.

FIG. 25 is a rear perspective view of the lighting assembly of FIG. 24, according to an exemplary embodiment.

FIG. 26 is a top view of the lighting assembly of FIG. 24, according to an exemplary embodiment.

FIG. 27 is a perspective view of the lighting assembly coupled to safety headwear with the first portion of the lighting assembly in a pivoted position, according to an exemplary embodiment.

### DETAILED DESCRIPTION

Referring generally to the figures, various embodiments of a safety headwear lighting system are shown. Safety headwear such as hard hats, helmets, etc. are used in a variety of construction jobs or other construction, residential, or commercial situations. Hard hats are often used in dim or poorly lit environments. In conventional lamp attachment systems, an operator couples a lamp that emits white light to a hard hat. However, as will be generally understood, because of brightness, white light can make it more difficult to see (e.g., have a blinding effect, harming night vision, etc.) particularly in dim or dark settings. In contrast, various embodiments of the safety headwear lighting system discussed herein include a headlamp supported by a mounting bracket with the headlamp emitting a red light for forward illumination. As such, a path for a wearer of the headlamp discussed herein is illuminated in red light rather than conventional white light. Applicant believes the use of red light allows for increased preservation of the wearer's night vision. In specific embodiments, the headlamp includes a red LED as a light source.

In various embodiments, the safety headwear lighting system discussed herein further includes a power source such as a battery pack supported by a bracket that is mounted to the hard hat. In such embodiments, the headlamp is mounted on a front portion of the hard hat while the power source is mounted on an opposing rear portion of the hard hat. In various embodiments, the power source includes one or more rear facing lighting elements. In specific embodiments, the battery pack includes two lighting elements that emit red light. In other words, the rear lighting elements act as tail lights for the wearer. In specific embodiments, the battery pack housing includes two red LEDs. Applicant believes the use of rear red light(s) on the power source of the lighting system as discussed herein provides improved visibility of the user from behind on work sights and/or dimly lit environments.

In various embodiments, the safety headwear lighting system discussed herein includes a circuit board such as a printed circuit board assembly (PCBA) within the headlamp. In specific embodiments, the circuit board controls at least some of the lighting elements in the headlamp and battery pack. In a specific embodiment, a first circuit board in the headlamp controls the lighting element(s) in the headlamp and a second circuit board in the battery pack controls the lighting element(s) in the battery pack. In a specific embodiment, the circuit board controls all of the lighting elements in the headlamp and battery pack. Applicant believes the position of a circuit board in the headlamp provides improved weight balance for the safety headwear lighting system.

In various embodiments, the safety headwear lighting system discussed herein includes a quick disconnect wire. In such embodiments, the quick disconnect wire extends between and connects the headlamp to the battery pack. In specific embodiments, the quick disconnect wire includes a quick disconnect connector along a length of the wire. In such an embodiment, if the wire connecting the headlamp and battery pack snags on an object, the quick disconnect connector will separate, turning off the headlamp and preventing further pulling on the lighting assembly. Applicant believes the use of a quick disconnect wire provides improved safety and reduces the likelihood of damage to the wire and/or other lighting assembly components if there is a snag of the wire.

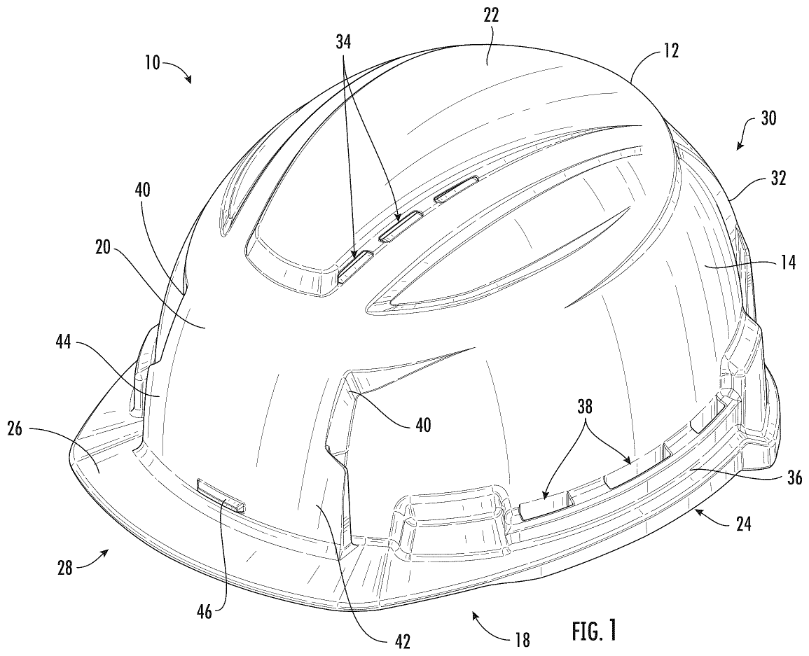

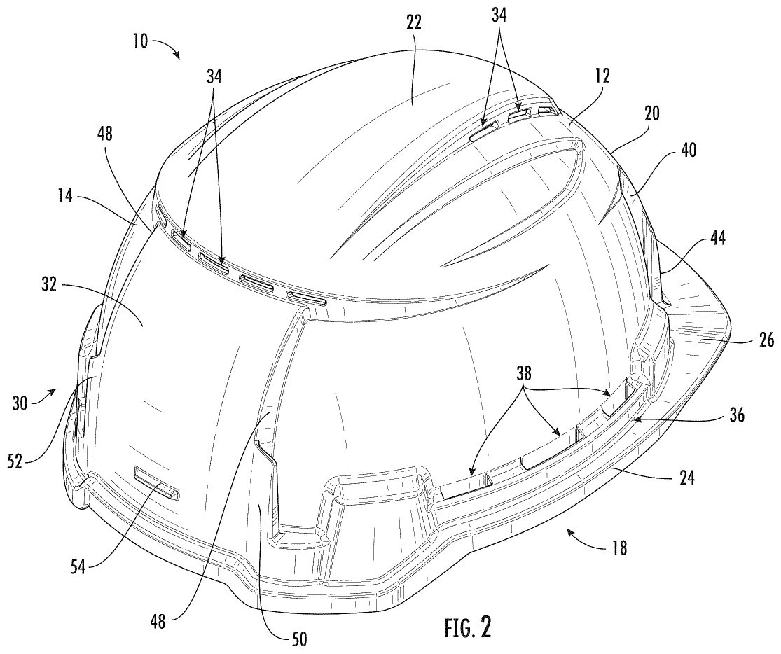

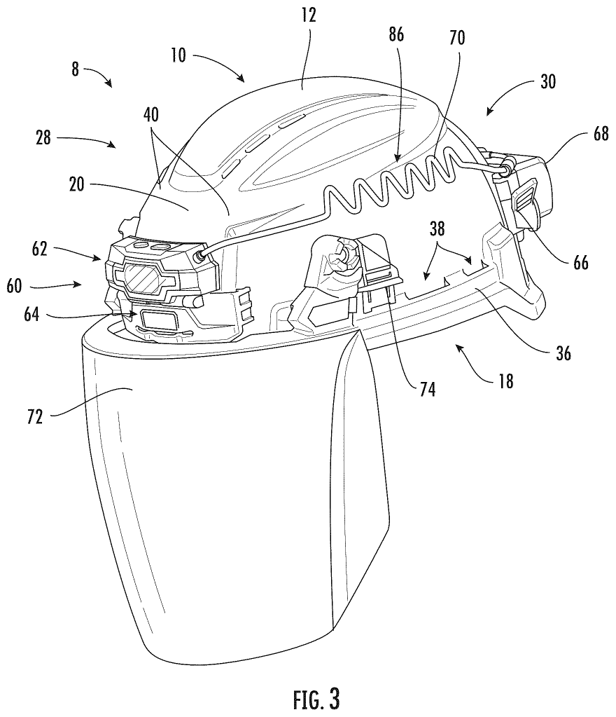

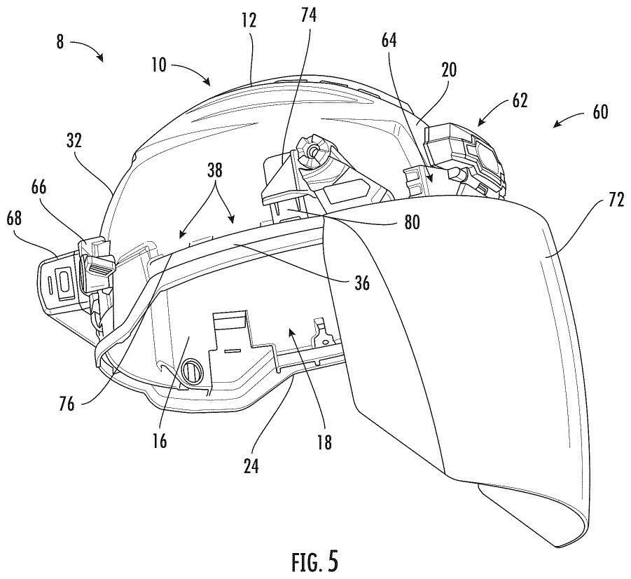

Referring to FIGS. 1-2, perspective views of safety headwear, shown as hard hat 10, are shown according to an exemplary embodiment. Hard hat 10 includes an outer shell 12. In a specific embodiment, outer shell 12 is formed from a rigid material, such as a rigid polymer material. Outer shell 12 includes an exterior surface 14 and an interior surface 16 (see e.g., FIGS. 2-3). Interior surface 16 defines a cavity 18 (see e.g., FIGS. 5-6 and 9) sized to receive a head of a user and/or wearer.

Outer shell 12 includes a crown portion 22 and a bottom segment 24 defining a lower circumference of hard hat 10. In various embodiments, a brim 26 extends radially outward from a portion of the lower circumference. In a specific embodiment, brim 26 extends radially outward from a front 28 of hard hat 10 and specifically outer shell 12. Outer shell 12 further includes a plurality of apertures or vents 34. Vents 34 extend through outer shell 12 providing fluid communication between cavity 18 and the ambient air proximate to exterior surface 14 of outer shell 12.

As will be discussed in greater detail below, various embodiments of hard hat 10 include one or more mounting ridges configured to couple to and/or support accessories. A side accessory support ridge or auxiliary mounting ridge 36 is positioned on a lateral side of outer shell 12 along the bottom segment 24. Auxiliary mounting ridge 36 includes a first end and a second end opposing the first end. A plurality of apertures or slots 38 are positioned along auxiliary mounting ridge 36 between the first end and the second end. Slots 38 are configured to receive a coupling mechanism, such as clips, or a portion of a hard hat accessory to couple the accessory to outer shell 12. Auxiliary mounting ridge 36 supports accessories for hard hat 10, such as ear muffs, tool or eyeglass holders, lamp supports, face shields, and/or reflectors, etc.

An additional side accessory support ridge or auxiliary mounting ridge 36 is positioned on a lateral side of outer shell 12 along the bottom segment 24. Hard hat 10 further includes a first mounting ridge shown as front mounting ridge 20 positioned on the front 28 of outer shell 12. Front mounting ridge 20 includes a first edge, shown as right edge 42 protruding outwardly from the front mounting ridge 20 and a second edge, shown as left edge 44 opposing the right edge 42 and protruding outwardly from the front mounting ridge 20. In specific embodiments, the right edge 42 and left edge 44 extend outward from opposing planar surfaces 40 positioned on each side of front mounting ridge 20.

In a specific embodiment, front mounting ridge 20 includes a detent 46 positioned on exterior surface 14 between the right edge 42 and the left edge 42 and configured to interface with a mounting bracket, such as mounting bracket 64 (see e.g., FIG. 3) and/or an accessory. In a specific embodiment, detent 46 is centered on front mounting ridge 20. The right edge 42 and left edge 44 of the front mounting ridge 20 each extend toward the bottom segment 24 of the outer shell 12. The right edge 42 and left edge 44 each include a portion with an increased width as the right edge 42 and left edge 44 approach the bottom segment 24 and/or the brim 26.

In various embodiments, the hard hat 10 includes a second mounting ridge shown as rear mounting ridge 32 located at the rear 30 of the hard hat 10. This allows a user to attach accessories and/or accessory mounting brackets to both the front 28 and rear 30 of hard hat 10 in addition to along the lateral portions of the hard hat 10 that include auxiliary mounting ridge(s) 36. Rear mounting ridge 32 is substantially the same as front mounting ridge 20.

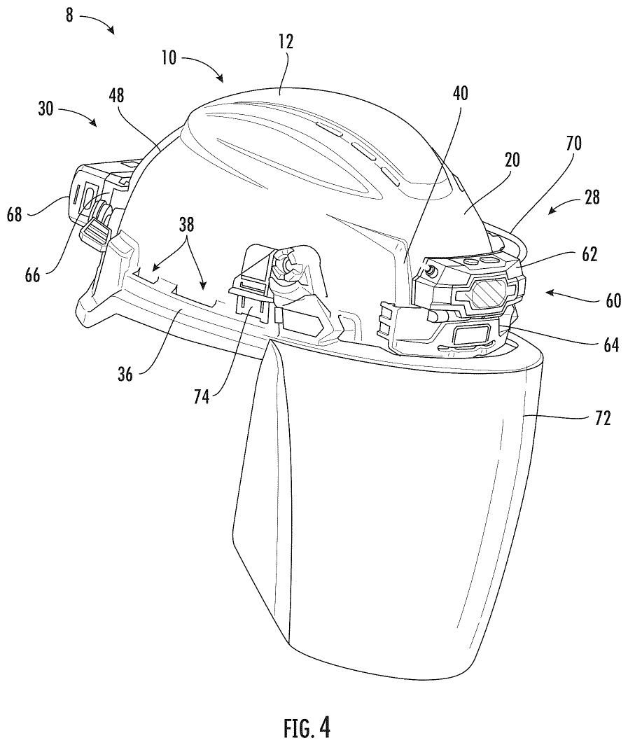

Rear mounting ridge 32 includes a first edge 50 protruding outwardly from the rear mounting ridge 32 and a second edge 52 opposing the first edge 50 and protruding outwardly from the rear mounting ridge 32. In specific embodiments, the first edge 50 and second edge 52 extend outward from opposing planar surfaces 48 positioned on each side of rear mounting ridge 32. In a specific embodiment, rear mounting ridge 32 includes a detent 54 positioned on exterior surface 14 between the first edge 50 and the second edge 52 and configured to interface with a mounting bracket, such as mounting bracket 66 (see e.g., FIG. 4) and/or an accessory.

Referring to FIGS. 3-10, various aspects of hard hat system 8 are shown according to an exemplary embodiment. In various embodiments, hard hat system 8 includes hard hat 10 and lighting assembly 60. As will be generally understood, lighting assembly 60 can be utilized with other safety headwear, helmets, etc. In various embodiments, lighting assembly 60 includes a bracket 64 that supports a lighting unit, shown as headlamp 62 and a mounting bracket 66 for a power source, shown as battery pack 68. Lighting assembly 60 couples to and is supported by hard hat 10.

Bracket 64 couples to hard hat 10, such as via being directly coupled to front mounting ridge 20. Headlamp 62 receives power from a power supply, shown as battery pack 68, via wire 70. In other words, in various embodiments, battery pack 68 is configured to supply electrical energy to an accessory coupled to the hard hat 10 (e.g., headlamp 62). In various embodiments, battery pack 68 includes a housing 67. In a specific embodiment, battery pack 68 includes a lithium USB battery. In various embodiments, headlamp 62 is coupled to a front 28 of hard hat 10 while battery pack 68 is coupled to the rear 30 of hard hat 10. As will be discussed in greater detail below, headlamp 62 is configured to provide outward visibility to a wearer and also make the wearer visible to others in the environment.

In a specific embodiment, battery pack 68 includes a removable and rechargeable battery used in lighting. In a specific embodiment, battery pack 68 includes an internal rechargeable (not removable) battery. In specific embodiments, battery pack 68 includes a single cell lithium ion battery. In other embodiment, battery pack 68 includes a plurality of batteries such as pouch cells.

In various embodiments, hard hat system 8 includes accessories that are supported by and/or removably coupled to hard hat 10 in addition to lighting system 60. An accessory, shown as face shield 72 is supported by one or more auxiliary mounting ridge(s) 36. Specifically, one or more mounting clips 74 are positionable within slot(s) 38 of auxiliary mounting ridge(s) 36 such that face shield 72 is supported by hard hat 10.

In various embodiments, wire 70 extends circumferentially around at least a portion of the exterior surface 14 of the outer shell 12 of hard hat 10. In various embodiments, wire 70 includes an expandable section of wire, shown as accordion section 86. The accordion section 86 is configured to permit wire 70 to increase a length over which the wire 70 extends. The accordion section 86 actuates between a retracted configuration and an extended configuration and is biased to the retracted configuration. The accordion section 86 further keeps the wire taut when the extra length is not needed to couple the headlamp 62 to battery pack 68. Wire 70 and specifically plug 84 couples to an outlet of battery pack 68. In a specific embodiment, plug 84 is an end with a 90 degree angle that couples to a top surface 102 of battery pack 68. With this structure, wire 70 stays snug against exterior surface 14 of hard hat 10 to avoid snags and catches.

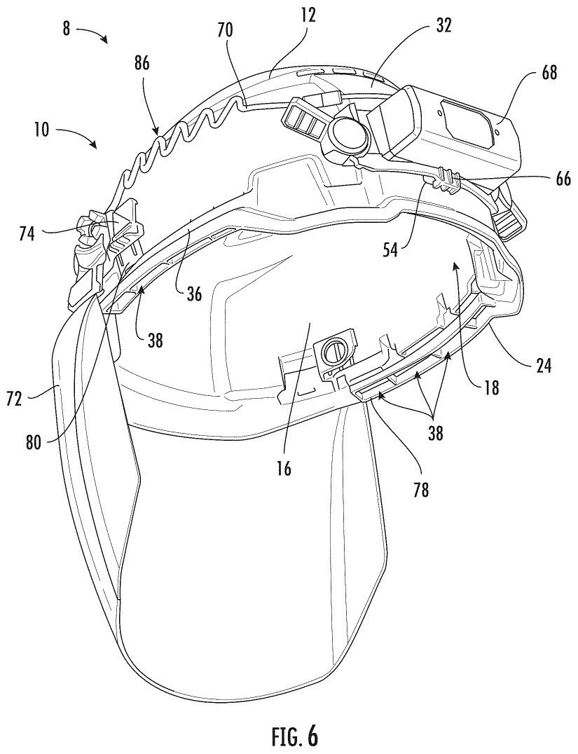

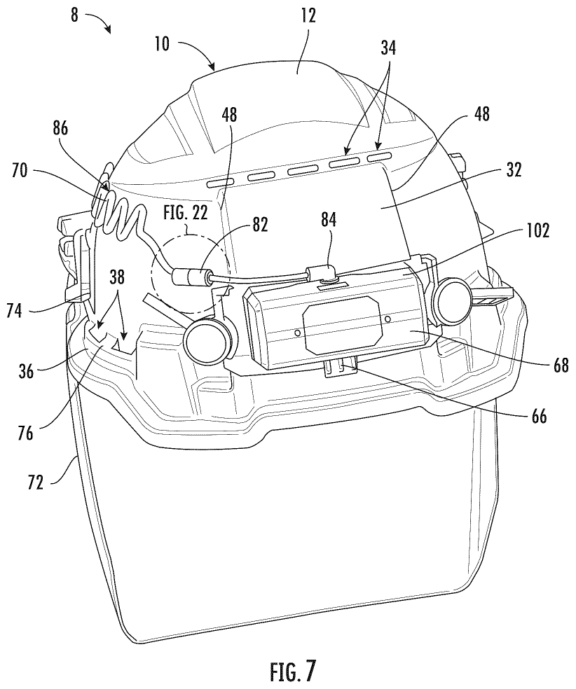

As shown in FIGS. 7-8, in specific embodiments, wire 70 is a quick disconnect wire. As will be discussed in greater detail below, in such an embodiment, wire 70 includes a quick disconnect connector 82 positioned along the length of wire 70. In particular, connector 82 is positioned between plug 84 and an opposing end 88 of wire 70 that is connected to headlamp 62.

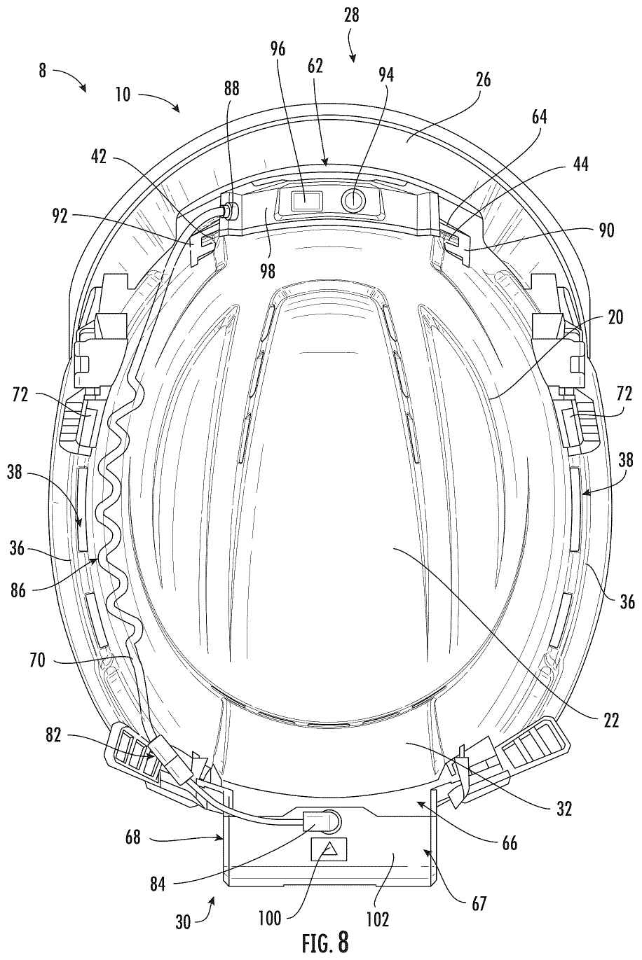

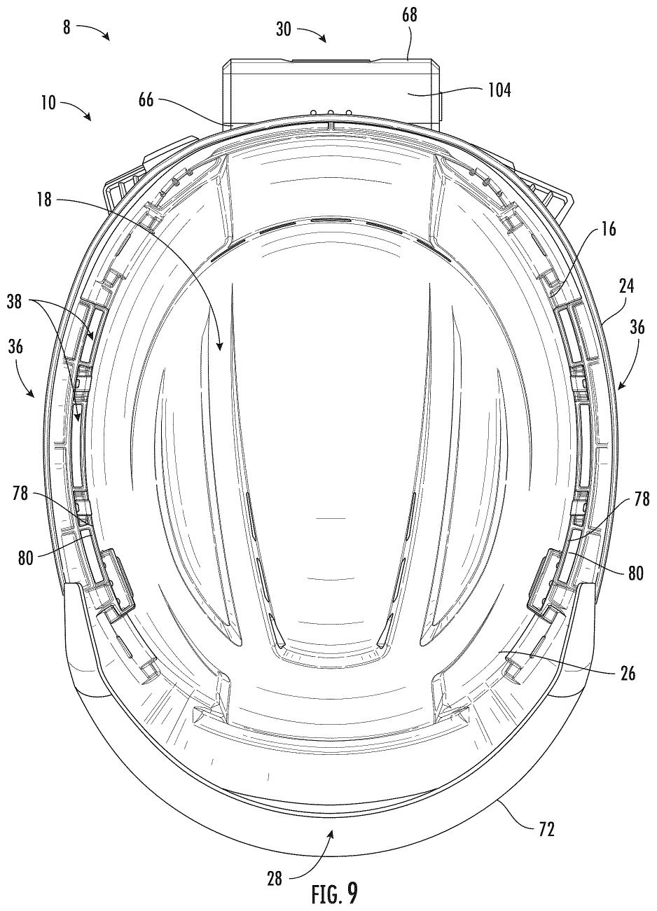

Referring to FIG. 9, a detailed bottom view of hard hat system 8 is shown according to an exemplary embodiment. Outer shell 12 and/or auxiliary ridge 36 includes a bottom edge 78 of each slot 38. The bottom edge 78 opposes a top edge 76 of auxiliary ridge 36. A depth of slot 38 is defined between bottom edge 78 and top edge 76. An engagement portion 80 of mounting clip 74 interfaces against and/or engages bottom edge 78 to secure an accessory such as face shield 72 to hard hat 10.

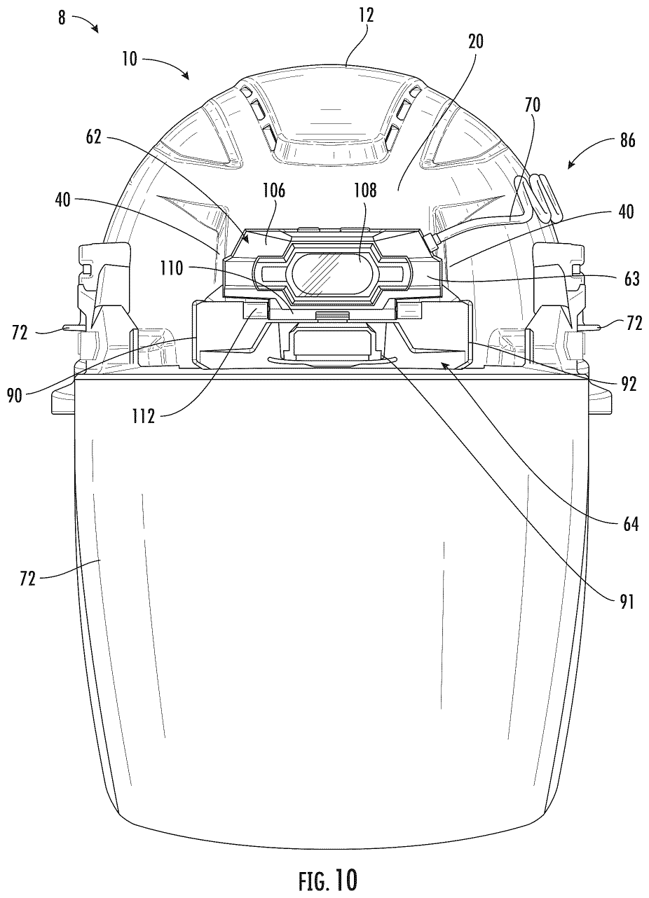

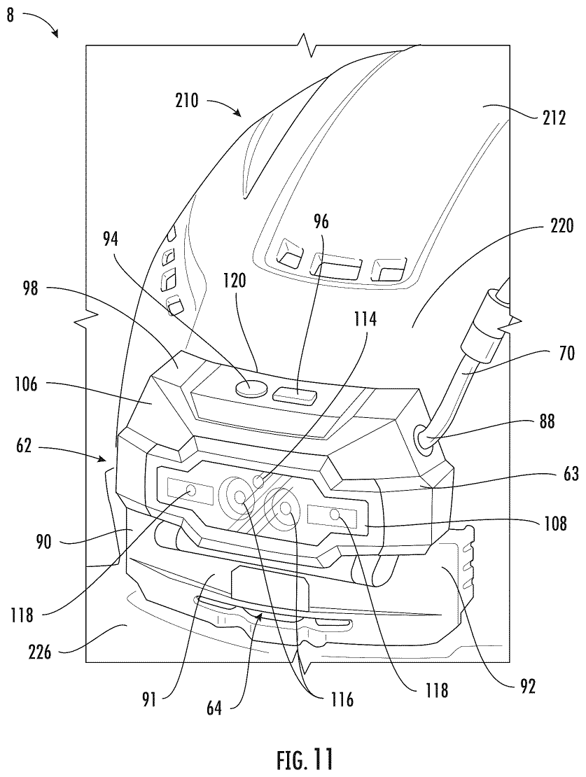

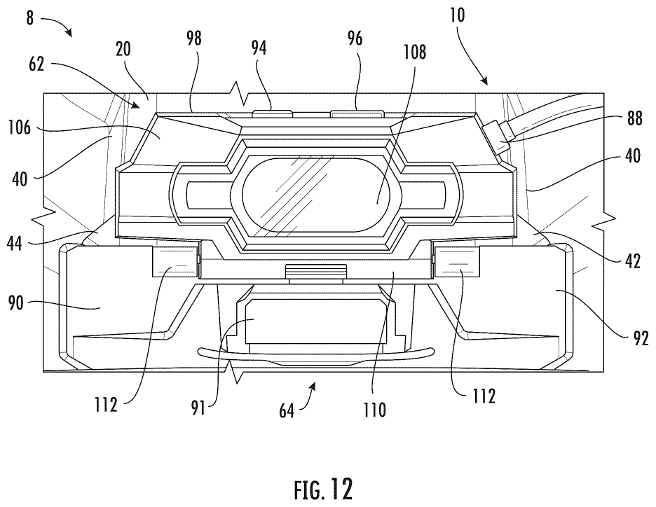

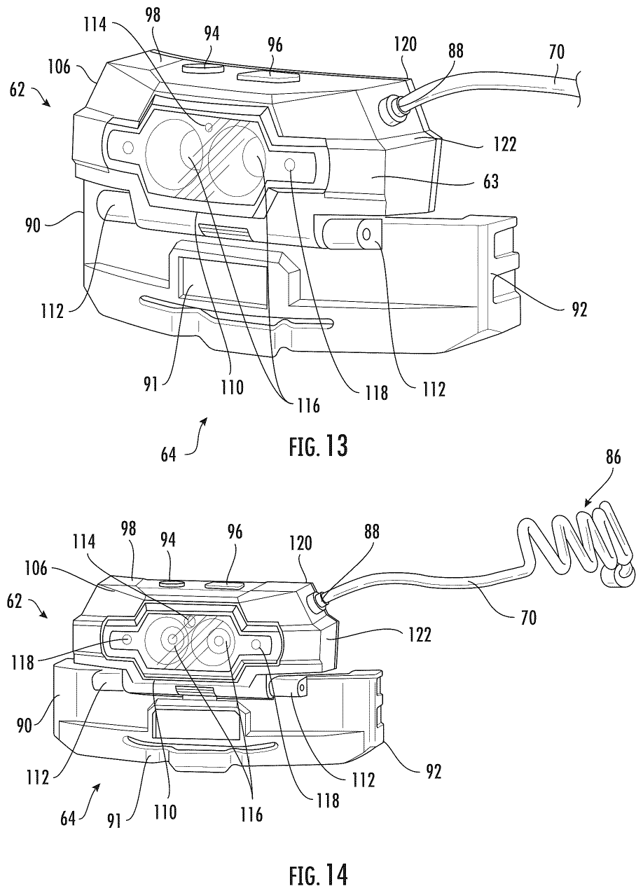

Referring to FIGS. 10-15, details of lighting assembly 60 and more specifically headlamp 62 and mounting bracket 64 are shown according to an exemplary embodiment. As shown in FIGS. 10-12, mounting bracket 64 and/or headlamp 62 are removably couplable to safety headwear, such as hard hat 10 or hard hat 210. Hard hat 210 is substantially the same as hard hat 10 except for the differences discussed herein.

In various specific embodiments, mounting bracket 64 is removably couplable to the outer shell 12, 212 and more specifically the front mounting ridge 20, 220 of the hard hat 10, 210. As will be generally understood, in other embodiments mounting bracket 64 and headlamp 62 could similarly be mounted on a different surface of the hard hat 10, 210. Mounting bracket 64 includes a main body 91 extending along a longitudinal or major axis of the mounting bracket 64. Main body 91 extends between a first arm 90 and a second arm 92. The first arm 90 and second arm 92 are configured to receive and engage the first edge (see e.g., 42) and second edge (see e.g., 44) of the front mounting ridge 20, 220 to secure mounting bracket 64 and/or headlamp 62 on the hard hat 10, 210.

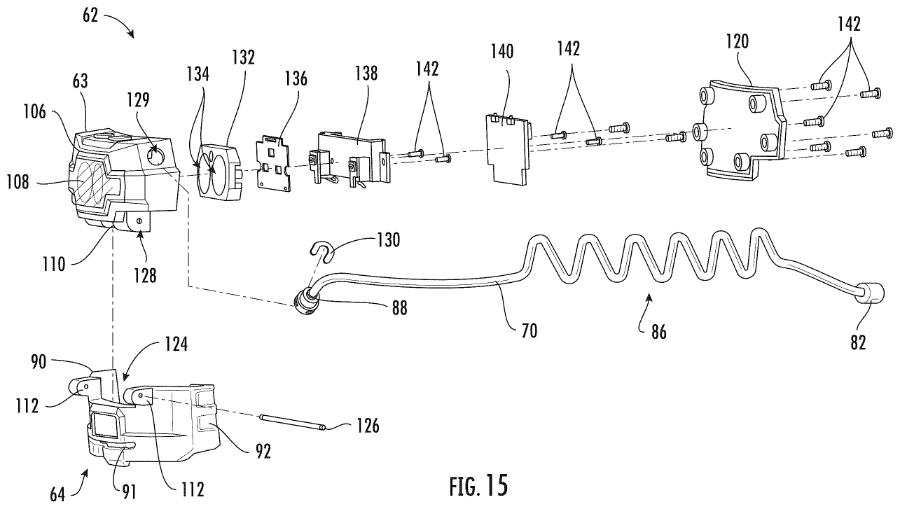

In various specific embodiments, headlamp 62 includes a housing 63. Housing 63 is defined by a front surface 106 facing away from front mounting ridge 20 and an opposing rear surface 120 that faces front mounting ridge. Housing 63 further includes a top surface 98. In specific embodiments, top surface 98 opposes an engagement portion 110. In various embodiments, housing 63 includes a pair of opposing side surfaces 122 that extend between and connect front surface 106 and rear surface 120. In specific embodiments, end 88 of wire 70 is coupled to a side surface 122 of housing 63 and/or headlamp 62. Engagement portion 110 and top portions 112 of bracket 64 together form a hinge. Top portions 112 of bracket 64 define a gap 124 configured to receive engagement portion 110 of headlamp 62. In other words, in various embodiments headlamp 62 is pivotably coupled to mounting bracket 64 and pivotable about a pin 126 (see e.g., FIG. 15).

Headlamp 62 and more specifically front surface 106 includes a lens 108. As previously discussed, in various specific embodiments, headlamp 62 includes a lighting element 114 that emits a red light for forward illumination. In specific embodiments, lighting element 114 is a red LED. As such, a forward path is illuminated in red light rather than conventional white light. Applicant believes the use of red light allows for increased preservation of the wearer's night vision, improving a wearer's ability to see details (e.g., read instructions, charts, etc.).

In various embodiments, headlamp 62 includes a plurality of lighting elements 114, 116, 118. In various specific embodiments, headlamp 62 includes a second lighting element, shown as a flood LED 116. As will be generally understood, the second lighting element 116 is a wide angle light. In various specific embodiments, headlamp 62 includes a third lighting element, shown as a spot LED 118. As will be generally understood, the spot lighting element 118 is a tighter range light. In specific embodiments, headlamp 62 includes the lighting element 114 that emits red light, a flood lighting element 116, and a spot lighting element 118. In specific embodiments, the flood lighting element 116 and the spot lighting element 118 emit a white light. In specific embodiments, headlamp 62 includes a pair of flood lighting elements 116, a pair of spot lighting elements 118, and the lighting element 114 that emits red light. In such an embodiment, the lighting element 114 is positioned above the flood lighting elements 116 and between the flood lighting elements 116 and top surface 98 of housing 63.

The various lighting elements (e.g., red light 114, flood light 116 and/or spot light 118) of headlamp 62 are controlled by one or more actuators 94, 96. In specific embodiments, headlamp 62 includes an actuator shown as a power button 94. In specific embodiments, power button 94 is positioned on top surface 98 of housing 63 of headlamp 62. In various embodiments, headlamp 62 includes a second actuator, shown as a mode button 96. In such an embodiment, the mode button 96 controls which of the lighting element(s) 114, 116, 118 is activated. In specific embodiments, mode button 96 is positioned on top surface 98 of housing 63 of headlamp 62. In a specific embodiment, lens 108 protects the one or more LEDs 114, 116, 118 and/or converges or diverges the emitted light.

Referring to FIG. 15, an exploded view of headlamp 62 and mounting bracket 64 are shown according to an exemplary embodiment. Headlamp 62 housing 63 further includes a hinge bore 128 extending though engagement portion 110 and configured to receive pin 126. A clip, shown as c-clip 130 is configured to secure end 88 of wire 70 within a cord bore 129 in side surface 122 of housing 63.

Headlamp 62 further includes a light source housing 132. Light source housing 132 includes one or more recessed sections 134 defined in a front surface. The recessed sections 134 are configured to receive the one or more lighting elements 114, 116, 118. A back 136 of light source housing 132 is coupled to the opposing rear surface that faces away from recessed sections 134. In a specific embodiments, the actuators 94, 96 provide input to a circuit board shown as printed circuit board assembly (PCBA) 140. When headlamp 62 is assembled PCBA is positioned within housing 63 between light source housing 132 and rear surface 120. A plurality of fasteners shown as screws 142 of various sizes are used to couple light source housing 132, support 138, PCBA 140 and/or rear surface 120 together to form an assembled headlamp 62.

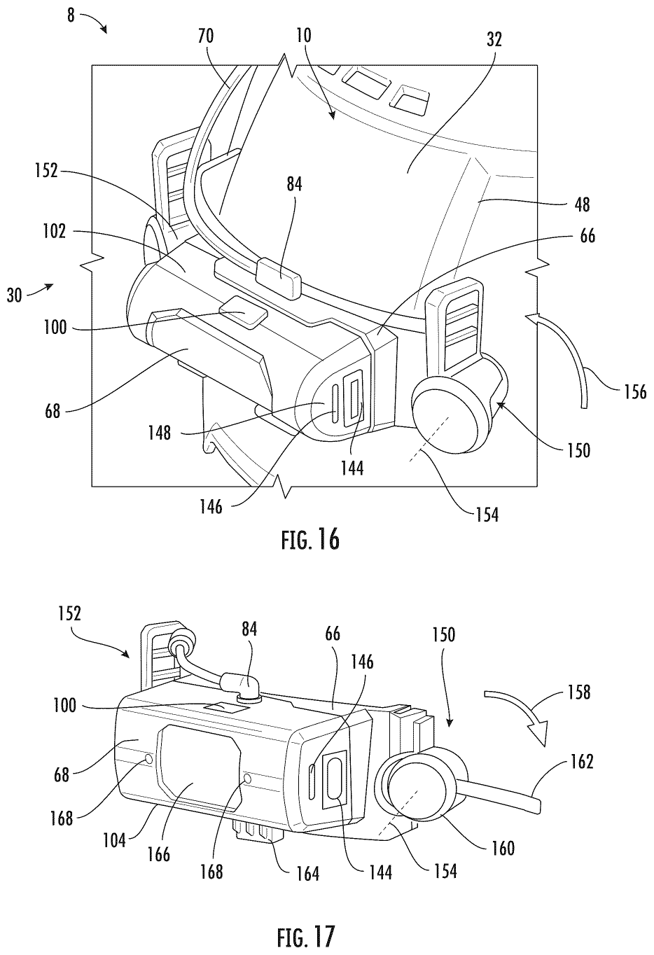

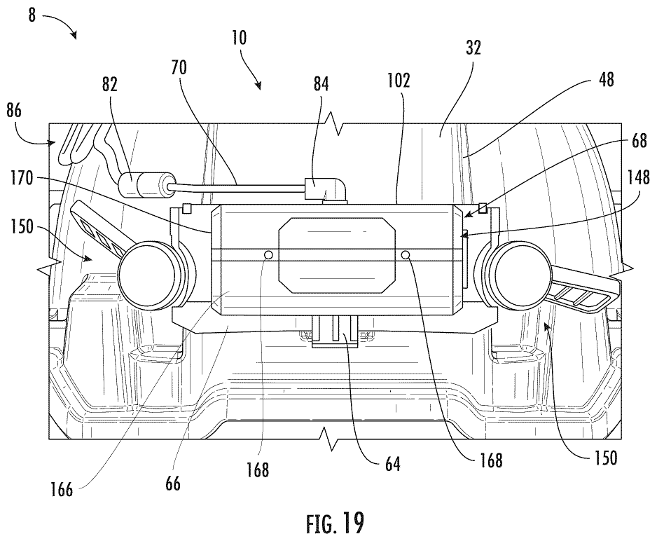

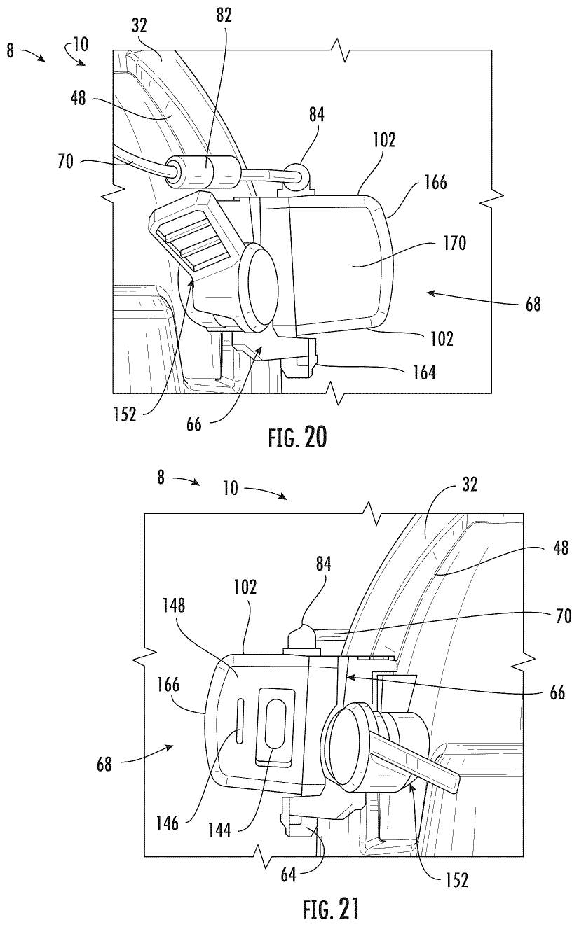

Referring to FIGS. 16-21, details of details of lighting assembly 60 and more specifically battery pack 68 and mounting bracket 66 are shown according to an exemplary embodiment. In various specific embodiments, mounting bracket 66 is removably couplable to the outer shell 12 and more specifically the rear mounting ridge 32 of the hard hat 10. As will be generally understood, in other embodiments mounting bracket 66 and battery pack 68 could similarly be mounted on a different surface of the hard hat 10. Mounting bracket 66 includes a main body 178 extending along a longitudinal or major axis of the mounting bracket 66. Main body 178 extends between a first end 180 and a second end 182. As will be discussed in greater detail below, the first end 180 and second end 182 are configured to engage the first edge (see e.g., 50 in FIG. 2) and second edge (see e.g., 52 in FIG. 2) of the rear mounting ridge 32 to secure mounting bracket 66 and/or battery pack 68 on the hard hat 10.

In various embodiment, mounting bracket 66 includes a cam lever 150. In a specific embodiment, mounting bracket 66 includes first cam lever 150 and second cam lever 152. In such an embodiment, the first cam lever 150 is positioned at a first end 180 of the mounting bracket 66 and rotatably coupled to mounting bracket 66. Similarly, second cam lever 152 is positioned at the second end 182 of the mounting bracket 66 and rotatably coupled to mounting bracket 66. Each cam lever 150, 152 includes a body portion 160 and a lever portion 162. Lever portion 162 extends away from body portion 160 along a longitudinal axis of cam levers 150, 152.

When cam levers 150, 152 are in a locked position, each lever portion 162 (see e.g., FIG. 17) extends along the opposing edges 50, 52 (i.e., in a generally parallel orientation to opposing planar surfaces 48 of rear mounting ridge 32. The first cam lever 150 is rotatable about a first axis of rotation 154 and the second cam lever 152 is rotatable about a second axis of rotation 154. The first and second axes of rotation 154 extend outward and forward from the mounting bracket 6 (see e.g., orientation in FIG. 17).

When an operator actuates cam levers 150, 152 in the first, locking direction shown by arrow 156, cam levers 150, 152 are rotated about an axis of rotation 154. As cam levers 150, 152 are moved in the locking direction 156, cam levers 150, 152 move toward main body 178 of mounting bracket 66. Axis of rotation 154 extends in a perpendicular orientation to a longitudinal axis of cam levers 150, 152. When cam levers 150, 152 are in a locked position, mounting bracket 66 clamps or compresses onto the edges 50, 52 of hard hat 10 to securely couple mounting bracket 66 to the rear mounting ridge 32 of the hard hat 10.

Referring to FIG. 17, a perspective view of mounting bracket 66 in a second, unlocked position is shown according to an exemplary embodiment. When the operator actuates cam levers 150, 152 in the second, unlocking direction shown by arrow 158, cam levers 150, 152 are rotated about axis of rotation 154. When cam levers 150, 152 are in the unlocked position, mounting bracket 66 unclamps and no longer compresses the edges 50, 52 of hard hat 10. When cam levers 150, 152 are in an unlocked position, each lever portion 162 extends in a direction away from the opposing planar surfaces 48 positioned on each side of rear mounting ridge 32 and/or away from main body 178 of mounting bracket 66.

Mounting bracket 66 further includes a tab, shown as a center tab 164 extending downward from the main body 178 toward the bottom segment 24 of a hard hat 10. Center tab 164 is configured to grip, hold and/or engage a retention cleat or detent (see e.g., 54 of FIG. 2) of the hard hat 10. The center tab 164 is positioned between cam levers 150, 152.

Battery pack 68 housing 67 includes an exterior surface 166 that faces away from mounting bracket 66, a first side surface 148, and a second side surface 170. Housing 67 further includes a top surface 102 facing upward (e.g., in opposite direction of center tab 164) and a bottom surface 104 that opposes top surface 102. In various embodiments, first side surface 148 includes a port, shown as USB port 144. As will be generally understood, USB port 144 allows for charging of battery pack 68.

In various embodiments, first side surface 148 includes a light 146. In specific embodiments, light 146 emits a color. For example, light 146 may emit a green color. In various embodiments, light 146 indicates a state of charge of battery pack 68. In such embodiments, when battery pack 68 is discharging and has a charge from 100%-50%, light 146 emits a green light. When battery pack 68 has a charge from 49%-10%, light 146 emits a yellow light. When battery pack 68 has a charge from 9%-3%, light 146 emits a red charge. When battery pack 68 has a charge from 3% to 0%, light 146 will blink red until power is completely depleted.

In various embodiments, battery pack 68 and light 146 emits different colors when battery pack 68 is charging. When battery pack 68 is charging and has a charge from 99%-50%, light 146 emits a yellow light. When battery pack 68 has a charge from 49%-0%, light 146 emits a red light. When battery pack 68 has a charge of 100%, light 146 emits a green light while connected to a charger. In such embodiments, light 146 will continue to emit green light continuously and for 3 second after being unplugged and/or disconnected.

In various embodiments, battery pack 68 and/or housing 67 includes an actuator, shown as a power button 100. In specific embodiments, power button 100 is positioned on top surface 102 of battery pack 68. In specific embodiments, battery pack 68 includes a lighting element 168. In a specific embodiment, battery pack 68 includes a pair of lighting elements 168. In specific embodiments, lighting element(s) 168 are positioned on exterior surface 166 that faces in a rear direction (e.g., away from mounting bracket 66 and hard hat 10). In specific embodiments, the lighting element(s) 168 emit red light. In other words, the rear lighting elements 168 act as tail lights for the wearer. In specific embodiments, the battery pack housing 67 includes two red LEDs. In such embodiments, battery pack 67 includes a first red LED and a second red LED spaced from the first red LED. As previously discussed, Applicant believes the use of rear red light(s) on the power source of the lighting assembly 60 as discussed herein provides improved visibility of the user from behind on work sights and/or dimly lit environments. Further, Applicant believes the use of red light allows for increased preservation of the night vision of other people and/or workers in the environment.

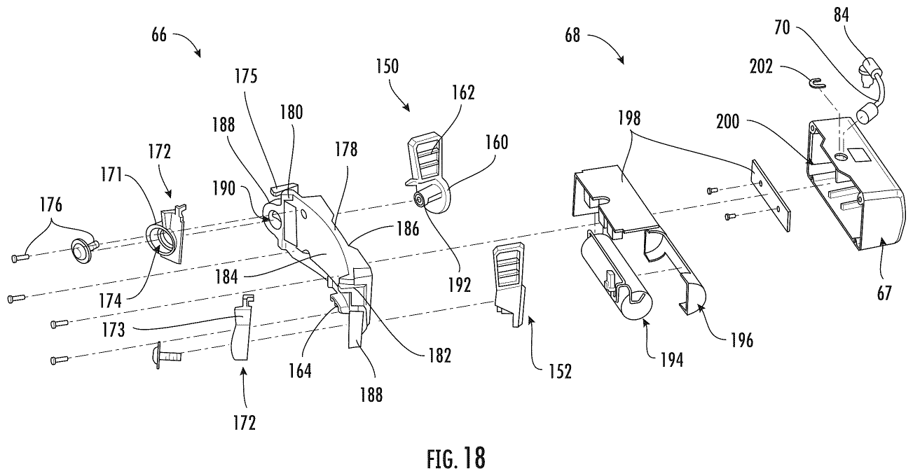

Referring to FIG. 18, an exploded view of battery pack 68 and mounting bracket 66 is shown according to an exemplary embodiment. Main body 178 further includes a pair of locking portions 188 on opposing sides of the front connection portion 186. Front connection portion 186 faces housing 67 of battery pack 68 and engages housing 67 when battery pack 68 is coupled to mounting bracket 66. Locking portions 188 are positioned below opposing end projections 175. Cam levers 150, 152 are rotatably coupled to mounting bracket 66 and specifically to locking portions 188. Locking portions 188 have a shape corresponding to cam levers 150, 152. Each locking portion 188 includes a bore 190 extending through the locking portion 188 along axis of rotation 154.

Mounting bracket 66 includes a pair of rear clamps 172. Each rear clamp 172 includes a clamping portion 173 and a clamp locking portion 171. Each clamp locking portion 171 includes a bore 174 extending through the clamp locking portion 171 along axis of rotation 154. A connector, shown as a screw 176 extends through bore 174 of each clamp locking portion 171 and bore 190 of the main body 178 along axis of rotation 154 when mounting bracket 66 is assembled.

When mounting bracket 66 is connected to rear mounting ridge 32, clamping portion 173 of rear clamp 172 and a rear surface 184 of main body 178 are positioned on opposing sides of edges 50, 52 respectively of hard hat 10. Rear clamp 172 and main body 178 together act as a vise to securely clamp onto hard hat 10. Each cam lever 150, 152 further includes a rearward extending projection 192. In other words, projection 192 extends toward main body 178 of mounting bracket 66.

Battery pack 68 further includes a cavity 200 defined by the housing 67 and front connection portion 185 of mounting bracket 66 when battery pack 68 is coupled to mounting bracket 66. In specific embodiments, battery pack 68 further includes a battery 194 and a battery housing 196 positioned within cavity 200. In various embodiments, battery pack 68 further includes one or more PCBAs 198 that are positioned within housing 67 and/or cavity 200. Battery pack 68 further includes a clip, shown as c-clip 202 to secure plug 84 to housing 67 and/or battery pack 68.

In various embodiments, lighting assembly 60 includes a circuit board such as a printed circuit board assembly (PCBA) 140 within the headlamp 62. In specific embodiments, the circuit board controls 140 at least some of the lighting elements 114, 116, 118, 168 in the headlamp 62 and battery pack 68. In a specific embodiment, a first circuit board 140 supported within the headlamp 62 controls the lighting element(s) 114, 116, 118, in the headlamp 62 and a second circuit board 198 supported within the battery pack 68 controls the lighting element(s) 168 in the battery pack 68. In a specific embodiment, the circuit board 140 controls all of the lighting elements 114, 116, 118, 168 in the headlamp 62 and battery pack 68. Applicant believes the position of a circuit board 140 in the headlamp 62 provides improved weight balance for the safety headwear lighting assembly 60. In a specific embodiment, headlamp 62 and mounting bracket 64 have a weight less than a maximum weight.

Applicant has found instead of having a significant portion of the weight in a rear position (e.g., 75% rear compared to 25%) a better weight balance can be achieved. Applicant believes a weight distribution closer to 50/50 is desirable. The weight balance is considered to be the weight of headlamp/total weight =front weight percentage. The rear weight percentage=100−front weight percent. The weight of the headlamp is defined as weight of the headlamp 62 and all internal components along with the mounting bracket 64 and wire 70. The rear weight is defined as the weight of battery pack 68 (i.e., battery housing and battery itself) and bracket 66.

In various embodiments, the front weight percentage is from 30% to 50% and the rear weight percentage is from 50% to 70%. In a specific embodiment, the front weight percentage is about 35% and the rear weight percentage is about 65%. In a specific embodiment, the headlamp 62 weight is about 83.7 g and the rear weight is 148 g. In a specific embodiment, the headlamp 62 weight is about 77.7 g and the rear weight is about 148.6 g. In such an embodiment, the total weight is 226.3 g.

In another specific embodiment, the front weight percentage is about 34% and the rear weight percentage is about 66%. In such an embodiment the total weight is 222 g, the front weight is 75 g, and the rear weight is 147 g. In a specific embodiment, the rear weight is 148 g or less. In various embodiments, the front weight is about 34% to about 35% of the total weight. In various embodiments, the maximum rear weight is 200 g or less.

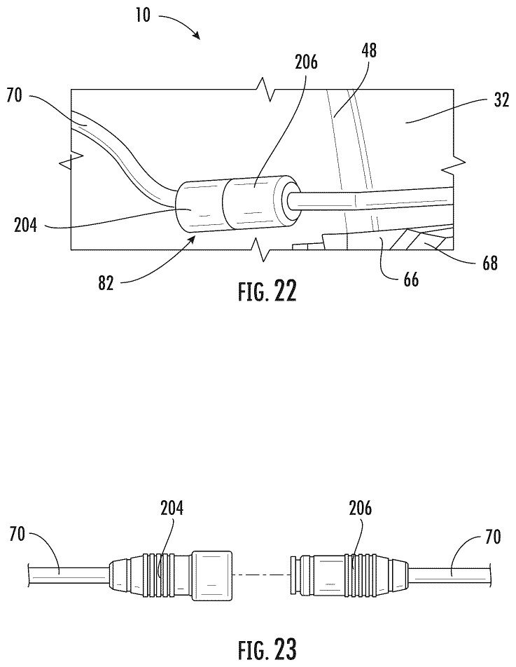

Referring to FIGS. 22-23, details of the quick disconnect wire 70 are shown according to an exemplary embodiment. In specific embodiments, wire 70 is a quick disconnect wire. Wire 70 includes a quick disconnect connector 82 positioned along the length of wire 70. In particular, connector 82 includes a first portion or connector 204 positioned between a second portion or connector 206 and the accordion section 86 of wire 70. In other words, connector 82 is positioned between plug 84 which is coupled to battery pack 68 and an opposing end 88 of wire 70 that is connected to headlamp 62. First connector 204 and second connector 206 are configured to disconnect if wire 70 becomes snagged or entangled and therefore prevent lighting assembly 60 from being pulled off of hard hat 10. In other words, when a force acts upon the wire 70 the first portion 204 and the second portion 206 of connector 82 disconnect.

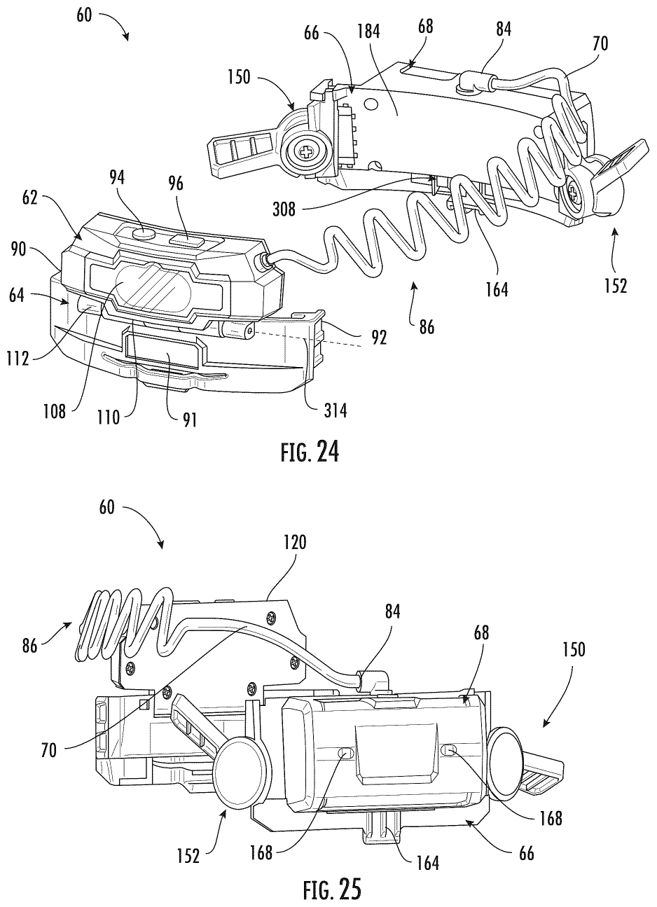

Referring to FIGS. 24-25, perspective views of lighting assembly 60 are shown according to an exemplary embodiment. Mounting bracket 66 and bracket 64 are removably couplable to safety headwear such as hard hat 10, 210. As will be generally understood, mounting bracket 66 and battery pack 68 and/or bracket 64 and headlamp can be separately removed from the safety headwear.

As shown in FIG. 24, mounting bracket 66 and specifically rear surface 184 includes a recess 308. Recess 308 is positioned above center tab 164. In specific embodiments, recess 308 is positioned on rear surface 184 between center tab 164 and top surface 102. Recess 308 is sized and/or configured to receive, grip, hold and/or engage the retention cleat or detent (see e.g., 54 of FIG. 2) of the hard hat 10, 210. Similar to center tab 164, recess 308 is positioned between cam levers 150, 152.

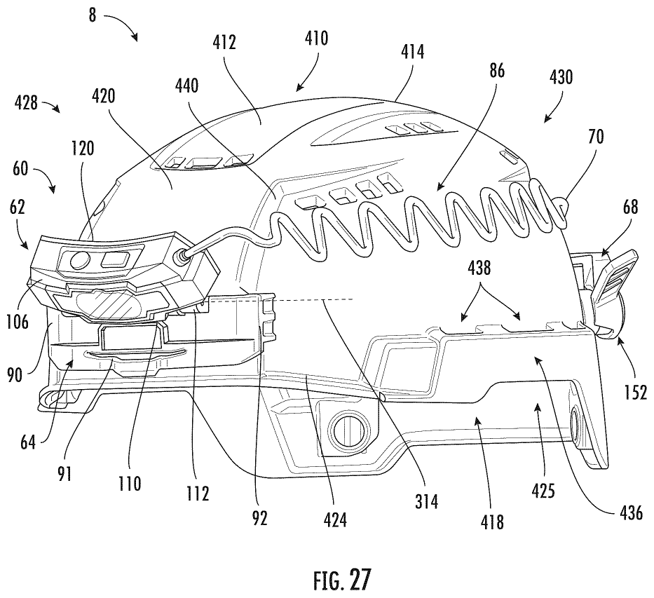

As previously discussed, engagement portion 110 and top portions 112 of bracket 64 together form a hinge. Top portions 112 of bracket 64 and engagement portion 110 of headlamp together define a pivot axis 314. In other words, in various embodiments headlamp 62 is pivotably coupled to mounting bracket 64 and pivotable about pivot axis 314 (see e.g., FIG. 27).

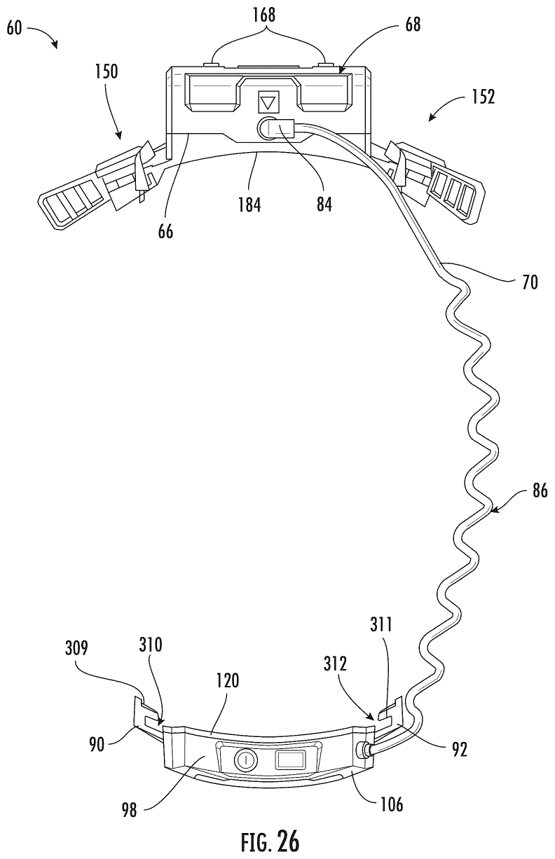

Referring to FIG. 26, lighting assembly 60 is shown from above, according to an exemplary embodiment. The first arm 90 and second arm 92 are configured to receive and engage the first edge (see e.g., 42) and second edge (see e.g., 44) of the front mounting ridge 20, 220 to secure mounting bracket 64 and/or headlamp 62 on the hard hat 10, 210. In other words, bracket 64 and in particular first arm 90 and second arm 92 engage front mounting ridge 20, 220 such that headlamp 62 is supported by the hard hat 10, 210.

First arm 90 further includes a rear projection 309 that defines a first space or gap 310 that receives and/or at least partially encloses the first edge on hard hat 10, 210, etc. Similarly, second arm 92 includes a second rear projection 311 that defines a second space or gap 312 that receives and/or at least partially encloses the second edge on hard hat 10, 210, etc.

Referring to FIG. 27, a front perspective view of a hard hat 410 supporting lighting assembly 60 according to another exemplary embodiment. Hard hat 410 is substantially the same as hard hats 10, 210 except for the differences discussed herein. Outer shell 412 includes recess 425 positioned between front 428 and rear 430 of hard hat 410. Recess 425 is positioned proximate to the ears of a wearer. In a specific embodiment, recess 425 extends a height above a portion of bottom segment 424 proximate to front 428 and/or rear 430 of hard hat 410. In specific embodiments, recess 425 is positioned along a portion of auxiliary mounting ridge 436.

As previously discussed, headlamp 62 is movable between an upright and/or generally vertical position (see e.g., FIGS. 10-14) and a pivoted position as shown in FIG. 27. Headlamp 62 is moveable from a first position, in which rear surface 120 is adjacent to exterior surface 414 and/or front mounting ridge 420 and a second position in which rear surface 120 is spaced from exterior surface 414 and/or front mounting ridge 420. In other words, as headlamp 62 pivots about pivot axis 314 into the second position, a distance between headlamp 62 and specifically rear surface 120 increases. As such, in the second, pivoted positioned, headlamp 62 is positioned at angle relative to bracket 64. In a specific embodiment, headlamp 62 is pivotable from an upright (i.e., vertical position) to a second angled position that is 70 degrees from the upright position. In other embodiments, the headlamp 62 may be pivotable over a different angular range.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A hard hat system comprising:
a hard hat comprising:
a shell comprising:
an exterior surface; and
an interior surface defining a cavity;
a front mounting ridge extending outward from a front of the exterior surface of the shell;
a rear mounting ridge extending outward from a rear of the exterior surface of the shell;
a lighting system comprising:
a first bracket configured to removably engage the front mounting ridge;
a headlamp supported by the first bracket, the headlamp comprising a first lighting element configured to emit a red light forward, in a first direction;
a second bracket configured to removably engage the rear mounting ridge;
a power source supported by second bracket, the power source comprising a second lighting element configured to emit a red light rearward, in a second direction that is opposite the first direction.

2. The hard hat system of claim 1, wherein the second lighting element is positioned on an exterior surface of the power source, the exterior surface of the power source facing away from the hard hat.

3. The hard hat system of claim 1, wherein the second lighting element comprises a first red LED and a second red LED spaced from the first red LED.

4. The hard hat system of claim 1, wherein the headlamp further comprises a flood lighting element and a spot lighting element, and wherein the flood lighting element and the spot lighting element are configured to emit a white light in the first direction.

5. The hard hat system of claim 1, further comprising a circuit board supported within the headlamp, wherein the circuit board is configured to control the first lighting element.

6. The hard hat system of claim 5, wherein the circuit board is configured to control the second lighting element.

7. The hard hat system of claim 5, further comprising a second circuit board supported within the power source, the second circuit board configured to control the second lighting element.

8. The hard hat system of claim 1, wherein the power source is a battery pack.

9. A hard hat system comprising:
a hard hat comprising:
a shell comprising:
an exterior surface; and
an interior surface;
a first mounting ridge extending outward from the exterior surface of the shell;
a second mounting ridge positioned on an opposite portion of the shell from the first mounting ridge, the second mounting ridge extending outward from the exterior surface of the shell;
a headlamp supported relative to the first mounting ridge via a first mounting bracket, the headlamp comprising a plurality of lighting elements, wherein at least one of the plurality of lighting elements is configured to emit a red light in a first direction;
a battery pack supported relative to the second mounting ridge via a second mounting bracket, the battery pack comprising a battery lighting element configured to emit a red light in a second direction that is opposite the first direction.

10. The hard hat system of claim 9, further comprising a wire connecting the battery pack and the headlamp, wherein the headlamp receives power from the battery pack via the wire.

11. The hard hat system of claim 10, wherein the wire comprises an expandable section that actuates between a retracted position in which the wire has a first length and an expanded position in which the wire has a second length, wherein the second length is greater than the first length.

12. The hard hat system of claim 10, wherein a front weight comprises a weight of the headlamp, the first mounting bracket, and the wire and a rear weight comprises a weight of the battery pack and the second mounting bracket, and wherein the front weight and the rear weight together define a total weight.

13. The hard hat system of claim 12, wherein the front weight is about 34% to about 35% of the total weight.

14. The hard hat system of claim 12, wherein the rear weight is 148 grams or less.

15. The hard hat system of claim 10, wherein the wire comprises a connector positioned between a first end of the wire engaged with the headlamp and a second end of the wire engaged with the battery pack.

16. The hard hat system of claim 15, wherein the connector comprises a first portion and a second portion removably coupled to the first portion, wherein, when a force acts upon the wire the first portion and the second portion disconnect.

17. A hard hat system comprising:
a hard hat comprising:
a shell comprising:
an exterior surface; and
an interior surface defining a cavity;
a mounting ridge extending outward from the exterior surface of the shell, the mounting ridge comprising:
opposing edges that protrude away from opposing sides of the mounting ridge;
a mounting bracket coupled to the mounting ridge, the mounting bracket including opposing arms that engage between the shell and the opposing edges of the mounting ridge; and
a power source supported by the mounting bracket, the power source configured to supply electrical power to an accessory coupled to the hard hat, the power source comprising:
a housing comprising a rear surface facing away from the hard hat; and
a pair of lighting elements positioned on the rear surface of the housing, wherein each of the pair of lighting elements are configured to emit red light.

18. The hard hat system of claim 17, wherein the pair of lighting elements are a pair of red LEDS.

19. The hard hat system of claim 17, further comprising:
a second mounting bracket configured to removably engage the hard hat; and
a headlamp supported by the second mounting bracket, the headlamp comprising a forward lighting element configured to emit a red light in a direction opposite the pair of lighting elements of the power source.

20. The hard hat system of claim 19, the hard hat further comprising a second mounting ridge configured to support the second mounting bracket, the second mounting ridge positioned on the exterior surface of the shell opposite from the mounting ridge, the second mounting ridge extending outward from the exterior surface of the shell and comprising opposing edges that protrude away from opposing sides of the second mounting ridge.
